(19) United States
(12) Patent Application Publication
(10) Pub. No.: US 2026/0362018 A1
(43) Pub. Date: Nov. 12, 2026

(54) IMAGE PROCESSING SYSTEM AND METHOD, IMAGE SIGNAL PROCESSOR, STORAGE MEDIUM, AND PROGRAM PRODUCT

(71) Applicant: Black Sesame Technologies Co., Ltd., Wuhan (CN)

(72) Inventors: Donghui Wu, San Mateo, CA (US); Zhaowei Xin, Wuhan (CN); Dongqing Yin, Wuhan (CN); Chao Wang, Wuhan (CN)

(21) Appl. No.: 19/371,570

(22) Filed: Oct. 28, 2025

(30) Foreign Application Priority Data
Oct. 30, 2024 (CN) 2024115389459

(51) Int. Cl. H04N 23/80; H04N 23/12

(52) U.S. Cl. CPC H04N 23/80; H04N 23/12

(57) ABSTRACT

[symbol]

resent application relates to an image processing system and method, an image signal [symbol] ssor (ISP), a storage medium, and a program product. The image processing system includes [symbol] or and an ISP. The ISP is configured to: calculate, every predetermined number of frames, a sensor parameter and an ISP parameter to be applied at a subsequent frame based on a current frame of image data; calculate an ISP compensation value; and write the sensor parameter into the sensor, and write the ISP parameter into the ISP after combining the ISP parameter with the ISP compensation value at a frame before a frame where the written sensor parameter takes effect in the sensor. The image data is processed using the written ISP parameter, and the processed image data is output.

### RELATED APPLICATION

This application claims the benefit under 35 U.S.C. § 119(a) of the filing date of Chinese Patent Application No. 2024115389459, filed in the Chinese Patent Office on Oct. 30, 2024. The disclosure of the foregoing application is herein incorporated by reference in its entirety.

### TECHNICAL FIELD

The present application relates to the field of image processing, and in particular, to an image processing system and method, an image signal processor, a storage medium, and a program product.

### BACKGROUND

In an image processing system, an image sensor closely cooperates with an image signal processor (ISP). The image sensor is used as a source of image data, a performance and an adjustment mode thereof have important influences on an effect of the whole system, and a processing flow of the ISP plays a key role in improving image quality. Currently, in the processing flow of the ISP, adjustment of the image sensor is completed through configuration of a register. Currently, writing and responding of the register of the image sensor cannot be completely synchronous, that is, modification of parameters of the register of the image sensor cannot take effect immediately. However, ISP parameters take effect in real time after being written into the ISP, resulting in a problem that effect taking times of the written parameters of the image sensor and the ISP are not synchronous. On the other hand, the writing and the responding of the register of the image sensor cannot be completely synchronous, which affects a response speed of the sensor, and then affects a convergence speed of an image processing process of the ISP. Thus, an image data stream output by the ISP has a certain delay for presentation of a change of a real-time scenario.

### SUMMARY

The present application provides an image processing system and method, an image signal processor, a storage medium, and a program product.

In an aspect, the present application relates to an image processing system, including: a sensor configured to collect multiple frames of image data, after being written into the sensor, a sensor parameter taking effect after at least 1 frame; and an image signal processor (ISP), after being written into the ISP, an ISP parameter taking effect immediately at a written frame, and the ISP including: an acquiring unit configured to acquire each frame of image data collected by the sensor; a calculating unit configured to calculate, every predetermined number of frames, a sensor parameter and an ISP parameter to be applied at a subsequent frame based on a current frame of image data; a writing unit configured to write the sensor parameter calculated based on the current frame of image data into the sensor, and write the ISP parameter into the ISP at a frame where the written sensor parameter takes effect in the sensor; and a processing unit configured to process the image data using the written ISP parameter and output the processed image data.

In another aspect, the present application relates to an image processing system, including: a sensor configured to collect multiple frames of image data, after being written into the sensor, a sensor parameter taking effect after at least 1 frame; and an image signal processor (ISP), after being written into the ISP, an ISP parameter taking effect immediately at a written frame, and the ISP including: an acquiring unit configured to acquire each frame of image data collected by the sensor; a calculating unit configured to calculate, every predetermined number of frames, a sensor parameter and an ISP parameter to be applied at a subsequent frame based on a current frame of image data, and calculate an ISP compensation value according to the sensor parameter calculated based on the current frame of image data and a sensor parameter calculated last time based on a previous frame of image data; a writing unit configured to write the sensor parameter calculated based on the current frame of image data into the sensor, and write the ISP parameter into the ISP after combining the ISP parameter with the ISP compensation value at a frame before a frame where the written sensor parameter takes effect in the sensor; and a processing unit configured to process the image data using the written ISP parameter combined with the ISP compensation value and output the processed image data.

In some embodiments, the calculating unit is further configured to calculate the ISP compensation value to correspond to a variation between the sensor parameter calculated based on the current frame of image data and the sensor parameter calculated last time based on the previous frame of image data.

In some embodiments, the calculating unit is further configured to calculate, as the ISP compensation value, a ratio of the sensor parameter calculated based on the current frame of image data to the sensor parameter calculated last time based on the previous frame of image data; the writing unit is further configured to write the ISP parameter into the ISP after multiplying the ISP parameter by the ISP compensation value.

In some embodiments, the writing unit is further configured to: determine whether the sensor parameter calculated based on the current frame of image data is the same as the sensor parameter calculated last time based on the previous frame of image data; and if not, write the sensor parameter calculated based on the current frame of image data into the sensor, and write the ISP parameter into the ISP after combining the ISP parameter with the ISP compensation value at the frame before the frame where the written sensor parameter takes effect in the sensor.

In some embodiments, the writing unit is further configured to: write the sensor parameter calculated based on the current frame of image data into the sensor and write the ISP parameter in combination with the ISP compensation value into the ISP at a last frame of the predetermined number of frames after the current frame.

In some embodiments, the image processing system further includes a memory, the memory being configured to temporarily store the multiple frames of image data collected by the sensor; wherein the predetermined number is greater than or equal to 2; after being written into the sensor, the sensor parameter takes effect after x frame(s), x being a positive integer less than the predetermined number; the acquiring unit is configured to: acquire each frame of image data collected by the sensor from the memory; and the writing unit is configured to rewrite the ISP parameter into the ISP without combining the ISP parameter with the ISP compensation value at the frame where the written sensor parameter takes effect in the sensor.

In some embodiments, the acquiring unit is configured to: directly acquire each frame of image data collected by the sensor from the sensor; and the predetermined number is 1.

In some embodiments, the image processing system includes a plurality of sensors; the ISP schedules a processing timing sequence of the image data collected by the plurality of sensors according to a calculation cycle of the image data collected by each sensor.

In another aspect, the present application relates to an image processing method for processing a stream including multiple frames of image data, including: acquiring each frame of image data collected by a sensor; calculating, every predetermined number of frames, a sensor parameter and an image signal processor (ISP) parameter to be applied at a subsequent frame based on a current frame of image data; writing the sensor parameter calculated based on the current frame of image data into the sensor, and writing the ISP parameter into an ISP at a frame where the written sensor parameter takes effect in the sensor; and processing the image data using the written ISP parameter and outputting the processed image data.

In another aspect, the present application relates to an image processing method for processing a stream including multiple frames of image data, including: acquiring each frame of image data collected by a sensor; calculating, every predetermined number of frames, a sensor parameter and an image signal processor (ISP) parameter to be applied at a subsequent frame based on a current frame of image data; calculating an ISP compensation value according to the sensor parameter calculated based on the current frame of image data and a sensor parameter calculated last time based on a previous frame of image data; writing the sensor parameter calculated based on the current frame of image data into the sensor, and writing the ISP parameter into an ISP after combining the ISP parameter with the ISP compensation value at a frame before a frame where the written sensor parameter takes effect in the sensor; and processing the image data using the written ISP parameter combined with the ISP compensation value and outputting the processed image data.

In another aspect, the present application relates to an image signal processor, including a logic circuit, the logic circuit being capable of executing a computer program stored in a memory, and the logic circuit, when executing the computer program, implementing the image processing method described above.

In another aspect, the present application relates to a non-transitory computer-readable storage medium having a computer program stored thereon, the computer program, when executed by a processor, implementing the image processing method described above.

In another aspect, the present application relates to a computer program product, including a computer program, the computer program, when executed by a processor, implementing the image processing method described above.

In the image processing system and method, the image signal processor, the storage medium, and the program product according to the present application, after being written into the sensor, the sensor parameter takes effect after several frames, while the ISP parameter takes effect immediately at the written frame after being written into a corresponding module of the ISP. On the one hand, by writing the ISP parameter into the ISP at the frame where the written sensor parameter takes effect in the sensor, the sensor parameter and the ISP parameter can synchronously take effect, thus improving image processing quality. On the other hand, by using the characteristic of a real-time response of the ISP to the written parameter, a delayed effect in the sensor is compensated in real time in the image stream output by the ISP by writing, into the corresponding module of the ISP, the ISP compensation value corresponding to the variation of the parameter in the sensor before and after the written sensor parameter takes effect in the sensor. When the image parameter changes, a compensation mechanism for a register write delay of the sensor is added into a software algorithm of the ISP to compensate the processing delay of hardware of the sensor, and the effect taking frame of the parameter in the image stream output by the ISP is at least 1 frame before the effect taking frame in the image stream collected by the sensor. Therefore, the processed image stream output by the ISP can reflect a change of a real-time scenario more quickly.

### BRIEF DESCRIPTION OF THE DRAWINGS

FIG. 1 shows a block diagram of an image processing system according to an embodiment of the present application;

FIG. 2 is a schematic operation diagram of an image processing system according to a first embodiment of the present application;

FIG. 3 shows a block diagram of an image processing system according to an embodiment of the present application;

FIG. 4 is another schematic operation diagram of the image processing system according to the first embodiment of the present application;

FIG. 5 is a schematic operation diagram of an image processing system according to a second embodiment of the present application;

FIG. 6 is another schematic operation diagram of the image processing system according to a second embodiment of the present application;

FIG. 7 is a flowchart of an image processing method according to an embodiment of the present application; and

FIG. 8 is a flowchart of an image processing method according to an embodiment of the present application.

### DETAILED DESCRIPTION

The technical solutions in the embodiments of the present application are clearly and completely described with reference to the accompanying drawings in the embodiments of the present application, and apparently, the described embodiments are not all but only a part of the embodiments of the present application. All other embodiments obtained by a person of ordinary skill in the art based on the embodiments of the present application without creative efforts shall fall within the protection scope of the present application.

In an image processing system, an image sensor closely cooperates with an image signal processor (ISP). Particularly in a vehicular environment, the ISP faces more specific and stringent requirements. With a development of a vehicle technology, automatic driving and assistant driving functions become more dependent on accurate and real-time image data processing. Since a vehicle tends to travel at a higher speed, an ambient environment changes rapidly, which requires that a data stream output based on the ISP can quickly respond to a change of a real-time scenario. Since writing and responding of a register of the image sensor are asynchronous, strict requirements for a real-time performance under the vehicular environment cannot be met. It may pose a potential threat to safe implementations of the automatic driving and assistant driving functions because inaccurate or delayed image data may lead to erroneous judgment of the system about the ambient environment, and then affect accuracy and safety of driving decisions. Based on this, an embodiment of the present application provides an image processing system capable of reflecting the change of the real-time scenario in real time, and performing low-delay and fast-convergence processing on large-scale data collected by the image sensor.

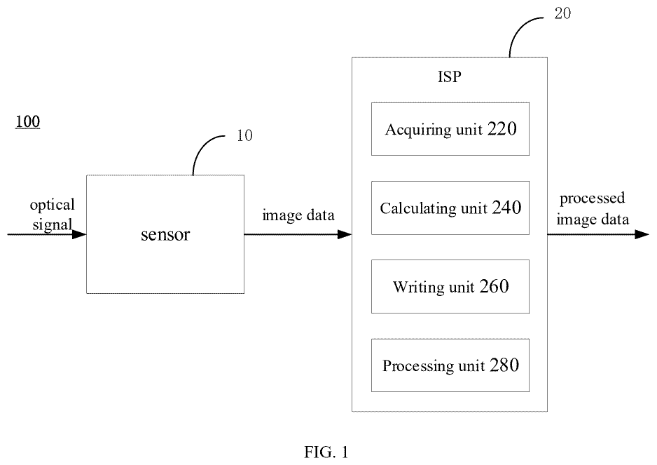

In an aspect, the present application provides an image processing system 100. FIG. 1 shows a block diagram of the image processing system 100 according to an embodiment of the present application. In this embodiment, the image processing system 100 includes a sensor 10 and an ISP 20.

The sensor 10 may be an image sensor configured to collect a plurality of frames of image data, and the image data may be understood as raw image data collected by the sensor 10. For example, the sensor 10 may continuously collect the multiple frames of image data to form an image data stream. Exemplarily, the image processing system 100 further includes an optical lens, the sensor 10 is connected to the optical lens, the optical lens focuses light onto the sensor 10, and the sensor 10 converts an optical signal into an electrical signal.

Adjustment of the sensor 10 is completed through configuration of a register of the sensor 10. The register, as a storage unit, may store various parameters associated with the sensor 10 including, but not limited to, an exposure time, a gain, a white balance, a resolution, etc. Correspondingly, the registers of the sensor 10 include registers for controlling various functions such as an exposure register for controlling automatic exposure, an analog gain register, and a white balance gain register required by the white balance. By configuring values in the registers, a working state of the image sensor can be accurately controlled to meet different application requirements. For example, adjusting the value of the exposure time register may change sensitivity of the image sensor to light, thereby affecting brightness of an image.

The configuration of the registers can be adjusted in real-time while the image processing system 100 is in operation, which enables the sensor 10 to adapt to different lighting conditions, scenario changes, and user needs. For example, in automatic exposure control (AEC), the image processing system 100 can adjust the sensor parameters such as the exposure time and the gain in real time according to brightness information of the image by modifying the values in the corresponding registers. In other words, the sensor parameter is converted into the value of the corresponding register through a calculation and written into the corresponding register, thereby writing the sensor parameter into the sensor 10.

According to characteristics of the sensor 10, the value of the register takes effect after at least 1 frame after being written into the register. That is, writing and responding of the register of the sensor 10 cannot be completely synchronous and the modification of the register cannot take effect immediately. In other words, the sensor parameter takes effect after at least 1 frame after being written into the sensor 10. The sensors 10 of different manufacturers and models exhibit different characteristics in this aspect. For example, the sensors 10 of the manufacturers such as Ominivision, On semiconductor, and Sony have an exposure and gain effect-taking mechanism that the sensor parameter takes effect after 2 frames after being written into the sensors 10 (the sensor parameter is written into the sensor 10 at Nth frame, and the written sensor parameter takes effect at (N+2)th frame), and the sensor 10 of Ominivision has a white balance gain effect-taking mechanism that the sensor parameter takes effect after 1 frame after being written into the sensor 10 (the sensor parameter is written into the sensor at the Nth frame, and the written sensor parameter takes effect at (N+1)th frame). In practical applications, it may cause an image processing delay and cannot adapt to the scenario change in time, thereby affecting quality of the image output by the image processing system 100 and a performance of the image processing system 100.

The sensor 10 in the present application is a common image sensor in the technical field of image processing, and the specific configuration thereof can be understood by those skilled in the art, and is not repeated herein.

The image signal processor (ISP) 20 is a device for processing output data of the image sensor, for example, performs processing of functions such as automatic exposure control (AEC), automatic gain control (AGC), automatic white balance (AWB), and color correction. The ISP is a device that includes a central processing unit (e.g., an MCU for calculating parameters), a data communication control bus, a data transmission interface, a general peripheral, a signal conditioning circuit, an image signal processing logic circuit, or the like. In the present application, the image signal processor may also be referred to as an image signal processing apparatus, which may be understood as a system of chip (SOC).

The ISP 20 is connected to the sensor, for example, through an I/O interface, and the ISP 20 is configured to acquire each frame of image data (electrical signal) collected by the sensor 10. In the case where the sensor 10 continuously collects the multi-frame image data stream, the sensor 10 transmits the image data to the ISP 20 via the I/O interface in real time every time the sensor 10 collects one frame of image data, the ISP 20 processes the electrical signal obtained by the sensor 10 to obtain a visual image, and the ISP 20 outputs the processed image data to obtain an image stream such as a video. The image stream output by the ISP 20 may be displayed by a display or stored by a memory.

Functions of the ISP 20 are achieved by the ISP logic circuit and firmware running thereon. The ISP logic circuit can complete algorithm processing of the firmware and can also count real-time information of the current image. The firmware acquires the image statistical information of the ISP logic circuit, the ISP 20 achieves functions of all processing modules through the firmware running thereon to form an ISP PIPE (processing function pipeline), so as to achieve the functions of automatic exposure control (AEC), automatic gain control (AGC), automatic white balance (AWB), or the like, and corresponding feedback control is performed on the ISP logic circuit and thus on the optical lens and the sensor 10, so that the aim of automatically adjusting the image quality is achieved. The firmware is a software algorithm program that runs on the ISP logic circuit, and may be stored in the memory inside the ISP (e.g., non-transitory memory such as a flash memory and an EPROM), or in a storage device outside the ISP.

The architecture of the ISP 20 according to the present application is an ISP architecture that is common in the technical field of image processing, and those skilled in the art can understand a specific structure thereof, which is not repeated herein.

Corresponding parameters need to be written into the ISP 20 to cause the ISP to function correspondingly. For example, an automatic exposure control (AEC) algorithm in the firmware automatically calculates an appropriate exposure parameter according to the brightness information of the image, and an automatic gain control (AGC) algorithm in the firmware automatically calculates a gain value according to intensity of an input signal. These automatically calculated ISP parameters are written into the ISP 20 to cause the ISP 20 to adjust processing of the image. The ISP parameter is written into a corresponding register in the ISP 20, for example. The ISP parameter takes effect at a written frame immediately after being written into the ISP 20. For example, the ISP 20 writes the ISP parameter at the Nth frame (in the present application, writing the ISP parameter at the Nth frame may be understood as writing the ISP parameter after an (N-1)th frame and before the Nth frame starts, or at the start of the Nth frame), the written ISP parameter takes effect at the Nth frame, and the ISP 20 processes the Nth frame of image data based on the written ISP parameter.

In the present application, the ISP 20 may include an acquiring unit 220, a calculating unit 240, a writing unit 260, and a processing unit 280, and the ISP 20 achieve functions of the acquiring unit 220, the calculating unit 240, the writing unit 260, and the processing unit 280 through software algorithms running thereon.

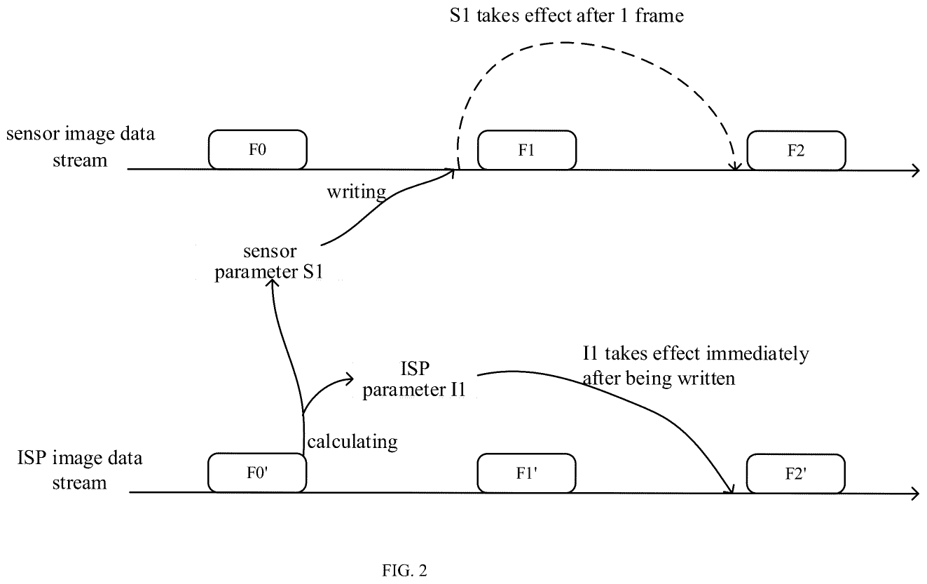

FIG. 2 is a schematic operation diagram of an image processing system according to a first embodiment of the present application, and operations performed by the image processing system according to the first embodiment of the present application are described in detail below with reference to FIG. 2. The operations performed by the ISP 20 may be implemented by the software algorithms running thereon.

The acquiring unit 220 of the ISP 20 may be configured to acquire each frame of image data collected by the sensor 10.

As can be seen from FIG. 1 and the above description, the sensor 10 is configured to collect the multiple frames of image data, which are shown in FIG. 2 as the image data stream F0-F2; the acquiring unit 220 of the ISP 20 is configured to acquire each frame of image data collected by the sensor 10 and process the collected image data to generate processed image data, which is shown in FIG. 2 as the processed image data stream F0′-F2′. Each frame in the image data stream of the ISP is obtained by image processing of the corresponding frame in the image data stream of the sensor by the ISP 20 applying the ISP parameter.

The calculating unit 240 of the ISP 20 may be configured to calculate, every predetermined number of frames, a sensor parameter and an ISP parameter to be applied at a subsequent frame based on a current frame of image data.

The sensor parameter and the ISP parameter have initial values for application during processing of a first frame of image. The sensor parameter to be applied at the subsequent frame is a parameter such as the exposure time and the gain that is applied when the sensor 10 collects the image data of the subsequent frame. The ISP parameter to be applied at the subsequent frame is a parameter applied when the ISP 20 processes the subsequent image frame, and includes parameters of each functional module of the ISP 20 such as an exposure parameter and a gain value, and parameters for performing overall control on the functional modules of the ISP 20. It is readily understood that the sensor parameter and the ISP parameter include parameters of the corresponding functions. For example, the sensor parameter includes an exposure time parameter and the ISP parameter correspondingly includes the exposure parameter.

Exemplarily, the predetermined number of frames may be one frame, in which case the ISP 20 calculates the sensor parameter and the ISP parameter for each frame; the predetermined number of frames may be two frames, in which case the ISP 20 makes a calculation every two frames to calculate the sensor parameter and the ISP parameter.

Specifically, when the sensor parameter and the ISP parameter are calculated, the ISP logic circuit in the ISP 20 performs parameter statistics on the current frame of image data, and the functional module of the ISP 20 calculates the sensor parameter and the ISP parameter to be applied at the subsequent frame based on the statistical parameters. The sensor parameter calculated each time is cached in a specific storage part of the ISP 20. It will be readily appreciated that the sensor parameter calculated each time may also be cached in a storage part located outside the ISP 20.

The writing unit 260 of the ISP 20 may be configured to write the sensor parameter calculated based on the current frame of image data into the sensor 10.

Specifically, the ISP converts the calculated sensor parameter into the value of the corresponding register of the sensor 10, and writes the value of the register into the corresponding register, thereby achieving writing the sensor parameter calculated into the sensor 10. It will be readily appreciated that the sensor parameter is written to the sensor 10 at a frame subsequent to the current frame, for example, the last frame of 1, 2 or more frames subsequent to the current frame.

The sensor parameter written to the sensor 10 is used by the sensor 10 to collect the subsequent frame of image data. However, as previously described, depending on the characteristics of the sensor 10, the sensor parameter written to the sensor 10 may not take effect immediately, and the sensor parameter written at the frame Fn may typically take effect at frame Fn+1 or Fn+2 or even later to adjust a collecting effect of the sensor 10 on the image data. It can be easily understood that the frame Fn+1 is the next frame of frame Fn, and frame Fn+2 is the next frame of frame Fn+1.

The writing unit 260 of the ISP 20 may be further configured to write the ISP parameter to the ISP 20 at the frame where the written sensor parameter takes effect in the sensor 10.

For example, in the case where the sensor parameter written at the frame Fn takes effect at the frame Fn+1, the ISP parameter may be written to the ISP 20 at the frame Fn+1. The ISP parameter may be written to the corresponding register in the ISP 20 corresponding to the functional modules in the ISP 20 such as AEC and AGC modules by addressing, and thus functions in these functional modules, so that the ISP 20 processes the image based on the written ISP parameter. It should be understood that functions achieved by writing the sensor parameter to the sensor 20 correspond to functions achieved by writing the ISP parameter to the ISP 20. It is easily understood that the frame in the sensor 10 has a corresponding relationship with the frame in the ISP 20, and the frames that are the same in the timing sequence indicate the same frame in the sensor 10 and the ISP 20.

The processing unit 280 of the ISP 20 may be configured to process the image data using the written ISP parameter and output the processed image data.

In the example shown in FIG. 2, at the Nth frame (e.g., frame F0′), the ISP 20 calculates the sensor parameter SI and the ISP parameter I1 based on the image data of the frame F0′. At the (N+1)th frame (e.g., frame F1), the calculated sensor parameter S1 is written to the sensor 10, and the written sensor parameter S1 takes effect in the sensor 10 after 1 frame. The calculated ISP parameter Il is written to the ISP 20 at the frame where the written sensor parameter takes effect in the sensor 10, i.e., the (N+2)th frame (e.g. frame F2′). The ISP 20 processes the image data using the ISP parameter I1 and outputs the processed image data, that is, outputs the processed image data of the frame F2′. Thus, the written sensor parameter S1 and ISP parameter I1 both take effect at the (N+2)th frame (e.g., frame F2 (or F2′)), that is, the image sensor parameter and the ISP parameter take effect synchronously. In this example, the calculation may be performed once per frame to calculate the sensor parameter and the ISP parameter, and an effect taking cycle thereof is 2 frames.

According to the above embodiment, by writing the ISP parameter into the ISP at the frame where the written sensor parameter takes effect in the sensor, the image sensor parameter and the ISP parameter can synchronously take effect, thus improving image processing quality.

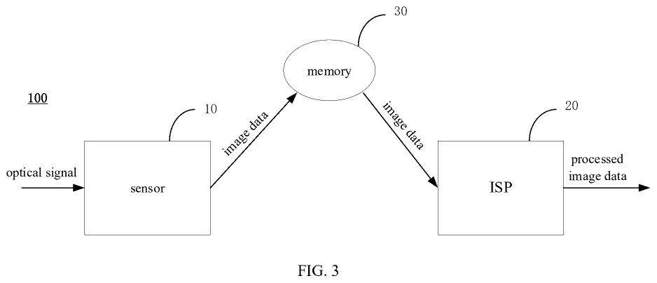

In some embodiments, as shown in FIG. 3, the image processing system 100 further includes a memory 30, the memory 30 being configured to temporarily store the plurality of frames of image data collected by the sensor 10. The ISP 20 in FIG. 3 may have the same architecture as the ISP 20 in FIG. 1. As will be readily understood by those skilled in the art, the ways in which the image data collected by the sensor 10 is put into the ISP 20 include an Inline mode and an Offline mode. For the Inline mode, the ISP 20 directly obtains the image data collected by the sensor 10 from the sensor 10, specifically, the image data enters the ISP 20 to be processed by the ISP PIPE immediately after flowing out of the sensor 10, and this mode has the characteristic of a low delay. For the Offline mode, the image data to be processed is stored in the memory 30 (for example, DDR memory) with frames as units, and after temporary storage in the memory 30, the ISP 20 reads the image data from the memory 30, so that the image data is processed by the ISP PIPE. The image processing system according to the present application is applicable to both the Inline mode and the Offline mode.

The Inline mode is applicable to the operation flow shown in FIG. 2; for the Offline mode, considering that a certain time is required for transmission of the image data through the memory, a calculation cycle of the parameter is slightly different from a writing cycle of the parameter.

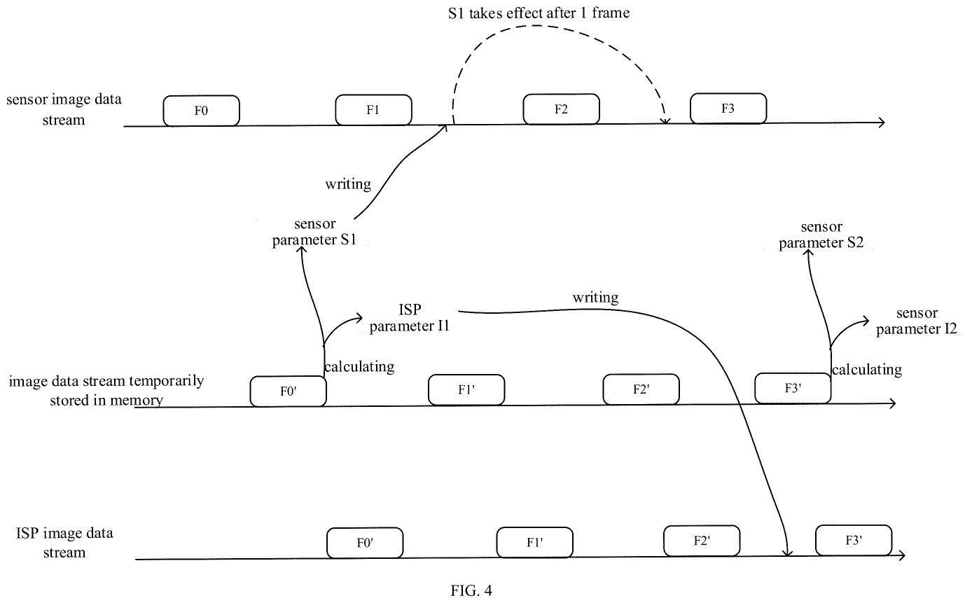

FIG. 4 shows another schematic operation diagram of the image processing system according to the first embodiment of the present application, and the Offline mode is adopted for this operation. In the example of FIG. 4, the acquiring unit 220 of the ISP 20 acquires each frame of image data collected by the sensor 10 from the memory 30. At the Nth frame (e.g., frame F0′), the ISP 20 calculates the sensor parameter S1 and the ISP parameter I1 based on the image data of the frame F0′. At the (N+2)th frame (e.g., frame F2), the calculated sensor parameter S1 is written to the sensor 10, and the written sensor parameter SI takes effect in the sensor 10 after 1 frame. The calculated ISP parameter I1 is written to the ISP 20 at the frame where the written sensor parameter takes effect in the sensor 10, i.e., the (N+3)th frame (e.g. frame F3′). The ISP 20 processes the image data using the ISP parameter I1 and outputs the processed image data, that is, outputs the processed image data of the frame F3′. Thus, the written sensor parameter S1 and ISP parameter I1 both take effect at the (N+3)th frame (e.g., frame F3 (or F3′)), that is, the image sensor parameter and the ISP parameter take effect synchronously. In this example, the calculation may be performed every 3 frames to calculate the sensor parameter and the ISP parameter, and the ISP parameter may be written every 3 frames.

The present application further provides an image processing system 100, the image processing system according to the second embodiment has a similar configuration to the image processing system according to the first embodiment, and the rest is the same as the image processing system according to the first embodiment except that the configurations of the calculating unit, the writing unit, and the processing unit are different from those of the image processing system according to the first embodiment. The description of the same parts is omitted, and only the differences from the image processing system according to the first embodiment are described below.

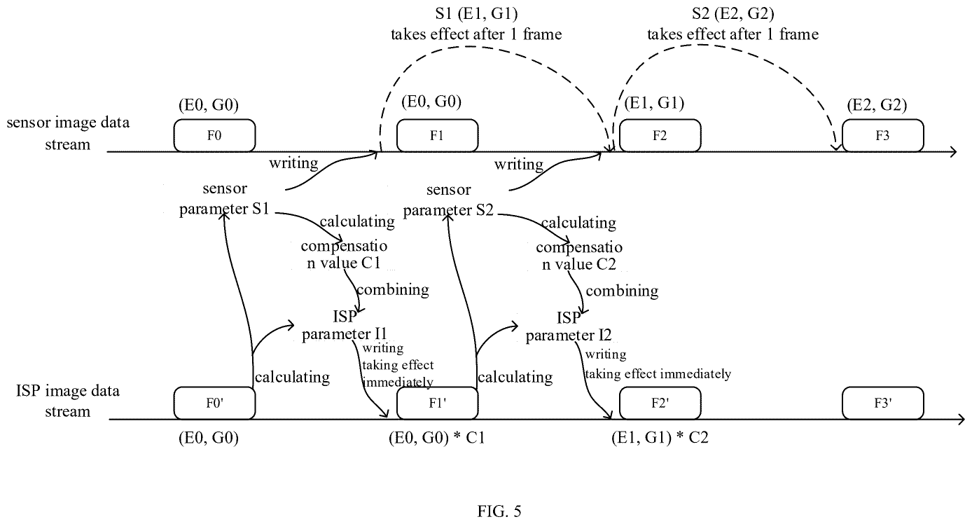

FIG. 5 is a schematic operation diagram of the image processing system according to the second embodiment of the present application, and operations performed by the image processing system according to the embodiment of the present application are described in detail below with reference to FIG. 5.

The calculating unit 240 of the ISP 20 may be further configured such that the ISP 20 calculates an ISP compensation value according to the sensor parameter calculated based on the current frame of image data and a sensor parameter calculated last time based on a previous frame of image data.

Specifically, for example, in the case where the predetermined number of frames is one frame, the last-time calculation is a calculation performed based on image data of the previous frame immediately before the current frame; in the case where the predetermined number of frames is two frames, the last-time calculation is a calculation performed based on image data of the first frame of two frames of image data before the current frame. It is easily understood that the previous frame refers to a frame previous to the current frame, and is not limited to a frame immediately before the current frame. That is, the ISP compensation value is calculated according to the currently calculated sensor parameter and the immediately preceding calculated sensor parameter. Since the sensor parameter calculated each time is cached in the specific storage part of the ISP 20, the sensor parameter calculated last time can be acquired from the specific storage part, thereby calculating the ISP compensation value. In the present case, the sensor parameter calculated last time refers to the sensor parameter derived from the calculation immediately preceding the current calculation and directly adjacent to the current calculation. In the case where the current calculation is the first calculation, the initial value of the sensor parameter is taken as the sensor parameter calculated last time. The initial value of the sensor parameter is a default value that the image processing system 100 gives to the sensor 10 at initialization. In this case, the writing unit 260 of the ISP 20 may be further configured to write the ISP parameter after combining the ISP compensation value to the ISP 20 at a frame before the frame where the written sensor parameter takes effect in the sensor 10.

For example, in the case where the sensor parameter written at the frame Fn takes effect at the frame Fn+2, the ISP parameter after being combined with the ISP compensation value may be written to the ISP 20 at the frame (e.g., frame Fn or Fn+1) before the frame Fn+2. The ISP compensation value may be a scaling multiplier (coefficient) of the ISP parameter calculated previously. The ISP compensation value is used to compensate the parameters in the sensor 10 before the written sensor parameter takes effect in the sensor 10 to the parameters in the sensor 10 after the written sensor parameter takes effect in the sensor 10 in the ISP image data stream.

Advantageously, at a same frame in the timing sequence as the frame where the sensor parameter is written to the sensor 10, the ISP parameter after being combined with the ISP compensation value is written to the ISP 20. The same frame in the timing sequence refers to frames in the ISP image data stream and the sensor image data stream that correspond in the timing sequence. The ISP parameter after being combined with the ISP compensation value is written to the ISP 20, which may mean that the ISP parameter is written to the ISP 20 after being multiplied by the ISP compensation value. It is easily understood that the ISP parameter written to the ISP 20 in this case is a parameter compensated by the ISP compensation value. The parameter may be written to the corresponding register in the ISP 20 by addressing, corresponding to the functional modules in the ISP 20 such as AEC and AGC modules, and thus functions in these functional modules. It should be understood that the functions achieved by writing the sensor parameter to the sensor 20 correspond to the functions achieved by writing the ISP parameter to the ISP 20. The writing of the ISP parameter in combination with the ISP compensation value to the ISP 20 and the writing of the sensor parameter to the sensor 10 are performed in the same frame in the timing sequence, that is, the writing of the ISP parameter and the writing of the sensor parameter are performed substantially synchronously.

In this case, the processing unit 280 of the ISP 20 may be configured to process the image data using the written ISP parameter combined with the ISP compensation value and output the processed image data.

As described above, according to the characteristics of the ISP 20, the ISP parameter written to the ISP 20 takes effect immediately in the written frame after being written to the ISP 20. That is, the image data is processed by applying the parameter at the frame where the ISP parameter is written, so that the change of the parameter is reflected in real time at the frame where the ISP parameter is written, thereby reflecting the change of the real-time scenario captured by the sensor 10.

Exemplarily, in the example shown in FIG. 5, the ISP 20 calculates the sensor parameter and the ISP parameter in each frame, that is, the predetermined number of frames is 1 frame. At the frame F0′, the ISP 20 calculates the sensor parameter S1 and the ISP parameter I1 based on the image data of the frame F0′. Since the calculation of the image data based on the frame F0′ is the first calculation, the initial value of the sensor parameter is taken as the sensor parameter calculated last time. Then, according to the sensor parameter S1 calculated based on the image data of the frame F0′ and the initial value of the sensor parameter, the ISP compensation value C1 is calculated. At the frame F1, the calculated sensor parameter S1 is written to the sensor 10, and the calculated ISP parameter I1 after combined with the calculated ISP compensation value C1 is written to the ISP 20 in the same frame in the timing sequence (i.e., frame F1′). The ISP 20 processes the image data using the ISP parameter I1 combined with the ISP compensation value C1 and outputs the processed image data, that is, outputs the processed image data of the frame F1′. In the sensor image data stream, the sensor parameter S1 calculated based on the image data of the frame F0′ takes effect at the frame F2; while in the ISP image data stream, the image data is processed at the frame F1′ using the parameter calculated based on the image data of the frame F0′, and the processed image data is presented. Thus, the effect taking frame of the relevant parameter in the ISP image data stream is one frame ahead of that in the sensor image data stream.

At the frame F1′, the ISP 20 calculates the sensor parameter S2 and the ISP parameter I2 based on the image data of the frame F1′. The calculation of the image data based on the frame F0′ is not the first calculation, the sensor parameter calculated last time is the sensor parameter S1 calculated based on the image data of the frame F0′, the sensor parameter S1 is cached in the specific storage part of the ISP 20, and the ISP 20 may directly acquire the sensor parameter S1 calculated last time from the specific storage part. Then, the ISP compensation value C1 is calculated from the sensor parameter S2 calculated based on the image data of the frame F1′ and the sensor parameter S1 calculated based on the image data of the frame F0′. At the frame F2, the calculated sensor parameter S1 is written to the sensor 10, and the calculated ISP parameter I2 is written to the ISP 20 in the same frame in the timing sequence (i.e., frame F2′) after combined with the calculated ISP compensation value C2. The ISP 20 processes the image data using the ISP parameter I2 after being combined with the ISP compensation value C2 and outputs the processed image data, that is, outputs the processed image data of the frame F2′. In the sensor image data stream, the sensor parameter S2 calculated based on the image data of the frame F1′ takes effect at the frame F3; while in the ISP image data stream, the image data is processed at the frame F2′ using the parameter calculated based on the image data of the frame F1′, and the processed image data is presented. Thus, the effect taking frame of the relevant parameter in the ISP image data stream is one frame ahead of that in the sensor image data stream.

Processing for the subsequent frame in FIG. 5 is similar to the above process, is not repeated in the drawing, and is not repeated herein.

According to the above technical solution, after being written into the sensor, the sensor parameter takes effect after several frames, and the ISP parameter takes effect immediately in the written frame after being written into the corresponding functional module of the ISP 20. By using the characteristic of a real-time response of the ISP 20 to the written parameter, a delayed effect in the sensor is compensated in real time in the image stream output by the ISP 20 by writing, into the corresponding functional module of the ISP 20, the ISP compensation value corresponding to the variation of the parameter in the sensor before and after the written sensor parameter takes effect in the sensor. When the image parameter changes, a compensation mechanism for a register write delay of the sensor is added into a software algorithm of the ISP 20 to compensate the processing delay of hardware of the sensor, and the effect taking frame of the parameter in the image stream output by the ISP 20 is at least 1 frame before the effect taking frame in the image stream collected by the sensor. Therefore, the processed image stream output by the ISP 20 can reflect a change of a real-time scenario more quickly.

In some embodiments, the calculating unit 240 of the ISP 20 is further configured to calculate the ISP compensation value to correspond to a variation between the sensor parameter calculated based on the current frame of image data and the sensor parameter calculated last time based on the previous frame of image data.

The delayed effect in the sensor is compensated in real time in the image stream output by the ISP by writing, into the corresponding module of the ISP, the ISP compensation value corresponding to the variation of the parameter in the sensor before and after the written sensor parameter takes effect in the sensor.

The variation between the sensor parameter calculated based on the current frame of image data (hereinafter, simply referred to as a currently calculated sensor parameter) and the sensor parameter calculated last time based on the previous frame of image data (hereinafter, simply referred to as a last-time calculated sensor parameter) may be a difference between the currently calculated sensor parameter and the last-time calculated sensor parameter or may be a ratio between the currently calculated sensor parameter and the last-time calculated sensor parameter.

Exemplarily, the calculating unit 240 may be configured to calculate a ratio of the currently calculated sensor parameter to the last-time calculated sensor parameter as the ISP compensation value; in this case, the writing unit 260 may be configured to write the ISP parameter to the ISP 20 after multiplying the ISP parameter by the ISP compensation value. In other words, the ISP compensation value is the ratio of the currently calculated sensor parameter to the last-time calculated sensor parameter; the ISP parameter is combined with the ISP compensation value by multiplication by the ISP compensation value. For example, for the parameter calculation of automatic exposure control (AEC) and automatic gain control (AGC), a form of calculating the ratio between the currently calculated sensor parameter and the last-time calculated sensor parameter as the ISP compensation value may be adopted.

Referring again to FIG. 5, at the frame F1′, the ISP compensation value C2 may be determined as the ratio of the sensor parameter S2 calculated based on the image data of the frame F1′ to the sensor parameter SI calculated based on the image data of the frame F0′ (S2:S1). In this case, the ISP compensation value may be a scaling multiplier (coefficient) of the ISP paramete calculated previously, that is, the ISP parameter is combined with the ISP compensation value by multiplication by the ISP compensation value, and the parameter written to the ISP 20 at the frame F2′ should be I2*C2=I1*(S2LS1). Thus, the ISP compensation value corresponds to the variation of the parameter in the sensor before and after the written sensor parameter takes effect in the sensor.

Exemplarily, with continued reference to FIG. 5, the initial value of the sensor parameter includes an exposure time parameter E0 and a gain parameter G0; the sensor parameter S1 calculated at the frame F0′ includes an exposure time parameter E1 and a gain parameter G1; the sensor parameter S2 calculated at the frame F1′ includes an exposure time parameter E2 and a gain parameter G2. In this case, the ISP compensation value calculated at the frame F0′ is C1=(E1*G1)/(E0*G0); the ISP compensation value calculated at the frame F1′ is C2=(E2*G2)/(E1*G1). It is therefore readily apparent that E0*G0*C1=E1*G1, that is, the effect of collecting the image by applying the sensor parameter taking effect at the frame F2 is equal to the effect of the ISP 20 outputting the processed image at the frame F1′; and El*G1*C2=E2*G2, that is, the effect of collecting the image by applying the sensor parameter taking effect at the frame F3 is equal to the effect of the ISP 20 outputting the processed image at the frame F2′, so that the effect taking frame of the relevant parameter in the ISP image data stream is one frame ahead of that in the sensor image data stream.

In some other examples, in the case where the variation between the currently calculated sensor parameter and the last-time calculated sensor parameter is the difference between the currently calculated sensor parameter and the last-time calculated sensor parameter, the writing unit 260 may be configured to write the ISP parameter into the ISP 20 after adding the ISP compensation value to the ISP parameter. For example, in the case of transforming operation of the parameter into operation in a log-domain, a scheme of calculating the difference between the currently calculated sensor parameter and the last-time calculated sensor parameter as the ISP compensation value may be adopted.

In some embodiments, the writing unit 260 of the ISP 20 may be configured to: determine whether the sensor parameter calculated based on the current frame of image data is the same as the sensor parameter calculated last time based on the previous frame of image data; and if not, write the sensor parameter calculated based on the current frame of image data into the sensor 10, and write the ISP parameter into the ISP 20 after combining the ISP parameter with the ISP compensation value at a frame before the frame where the written sensor parameter takes effect in the sensor 10.

Specifically, referring again to FIG. 5, at the frame F1′, the sensor parameter calculated based on the current frame of image data is the sensor parameter S2, and the sensor parameter calculated last time based on the previous frame of image data is the sensor parameter S1. As can be seen from the foregoing description, the last-time calculated sensor parameter S1 is cached in the specific storage part of the ISP 20, and the ISP 20 may directly obtain the last-time calculated sensor parameter S1 from the specific storage part for comparison. The ISP 20 determines (e.g., compares) whether the sensor parameter S2 is the same as the sensor parameter S1, and if not (i.e., S2/S1), writes the sensor parameter S2 calculated based on the current frame of image data into the sensor 10, and writes the ISP parameter I2 into the ISP 20 after combining the ISP parameter I2 with the ISP compensation value C2 at a frame (i.e., the frame F2′ in the example of FIG. 5) before the frame where the written sensor parameter S2 takes effect in the sensor 10.

On the other hand, in the case where the sensor parameter S2 is the same as the sensor parameter S1, the ISP parameter is written into the ISP 20 after being combined with the ISP compensation value at the frame before the frame where the written sensor parameter takes effect in the sensor 10, without writing the sensor parameter calculated based on the current frame of image data into the sensor 10. In the case where the sensor parameter S2 is the same as the sensor parameter S1 (S2=S1), the writing of the sensor parameter S2 to the sensor 10 is not performed, only the ISP parameter I2 is written to the ISP 20, and the writing timing of the ISP parameter I2 may be the last frame of the predetermined number of frames after the frame where the ISP parameter and the sensor parameter are calculated; in this way, the sensor 10 directly adopts the previously written sensor parameter S1, thus saving overhead of system resources for writing the sensor parameter into the sensor 10. In this case, in the case where the ISP compensation value C2 is the ratio (S2:S1) of the sensor parameter S2 calculated based on the current frame (F1′) of image data to the sensor parameter S1 calculated last time based on the previous frame of image data (F0′), when the sensor parameter S2 is the same as the sensor parameter S1, the ISP compensation value C2 is 1; the ISP compensation value C2 is used as the scaling multiple of the calculated ISP parameter I2, and when the ISP compensation value C2 is 1, it indicates that the ISP parameter I2 in this case may not need compensation, and the ISP parameter can be directly written into the ISP 20.

In this embodiment, before the sensor parameter calculated based on the current frame of image data is written into the sensor 10, whether the sensor parameter calculated based on the current frame of image data is the same as the sensor parameter calculated last time based on the previous frame of image data is determined, and only when the sensor parameters are not the same, the sensor parameter calculated based on the current frame of image data is written into the sensor 10. The determination of whether the sensor parameter calculated based on the current frame of image data is the same as the sensor parameter calculated last time based on the previous frame of image data may be performed before or after the ISP compensation value is calculated, as long as it is performed after the sensor parameter calculated based on the current frame of image data and the sensor parameter calculated last time based on the previous frame of image data are obtained. In addition, as an additional embodiment, the ISP 20 may convert the sensor parameter calculated based on the current frame of image data into the value of the corresponding register for writing the value into the corresponding register, and determine whether the sensor parameter calculated based on the current frame of image data is the same as the sensor parameter calculated last time based on the previous frame of image data by determining whether the currently converted value of the register is the same as the value of the register taking effect in the sensor 10.

In some embodiments, the writing unit 260 of the ISP 20 may be further configured to: write the sensor parameter calculated based on the current frame of image data into the sensor 10 and write the ISP parameter after combining with the ISP compensation value into the ISP 20 at a last frame of the predetermined number of frames after the current frame.

According to the foregoing description, the ISP 20 calculates, every predetermined number of frames, the sensor parameter and the ISP parameter to be applied at the subsequent frame based on the current frame of image data. That is, the predetermined number of frames is the calculation cycle of the ISP 20. For example, the ISP 20 performs one calculation every x frame(s) to calculate the sensor parameter and the ISP parameter to be applied to the subsequent frame, and the current frame for the calculation of the ISP 20 is the Nth frame; in this case, the timing of writing the sensor parameter to the sensor 10 and the timing of writing the ISP parameter to the ISP 20 after the ISP parameter is combined with the ISP compensation value should be the (N+x)th frame. Exemplarily, in the example shown in FIG. 5, the calculation cycle of the ISP 20 is 1 frame, that is, the calculation is performed every 1 frame, and the calculated parameter is written into the sensor 10 and the ISP 20 at the frame immediately after the frame for the calculation. According to the above solution, the calculation cycle of the ISP 20 and the writing cycle are kept the same, so that the processing flow of the image processing system can be efficiently controlled.

The image processing system 100 according to the second embodiment is also applicable to the Inline mode and the Offline mode.

In some embodiments, the image processing system 100 further includes a memory 30, the memory 30 being configured to temporarily store the multiple frames of image data collected by the sensor 10; the predetermined number is greater than or equal to 2; after being written into the sensor 10, the sensor parameter takes effect after x frame(s), x being a positive integer less than the predetermined number; the acquiring unit 220 of the ISP 20 may be further configured to: acquire each frame of image data collected by the sensor 10 from the memory 30; and the writing unit 260 of the ISP 20 may be further configured to rewrite the ISP parameter into the ISP 20 without combining the ISP parameter with the ISP compensation value at the frame where the written sensor parameter takes effect in the sensor 10.

In this embodiment, the image processing system 100 employs the Offline mode. The image processing system 100 is, for example, the image processing system 100 shown in FIG. 3. The memory 30 temporarily stores the multiple frames of image data collected by the sensor 10, and each frame of image data may be formed by fusing multi-exposure data. For example, a high dynamic image (HDR) may be output as one frame by fusing data of different exposures (long, medium, and short exposures). The ISP 20 acquires each frame of image data collected by the sensor 10 from the memory 30. In this case, the predetermined number is 2 or more, that is, the sensor parameter and the ISP parameter are not continuously calculated every frame, and several frames are provided between two calculations. After being written into the sensor 10, the sensor parameter takes effect after x frame(s), x being a positive integer less than the predetermined number. For example, when the predetermined number is 3, the ISP 20 performs one calculation every 3 frames to calculate the sensor parameter and the ISP parameter; when the sensor parameter is written to the sensor 10 in at Nth frame, the sensor parameter takes effect at the (N+x)th frame, and since x is a positive integer less than 3, the sensor parameter may take effect at the (N+1)th frame or the (N+2)th frame. In this case, the ISP 20 may be configured to: at the frame where the written sensor parameter takes effect in the sensor 10, i.e., the (N+x)th frame, rewrite the ISP parameter to the ISP 20 without combining the ISP parameter with the ISP compensation value. That is, only the ISP parameter is rewritten to the ISP 20, without being combined with the ISP compensation value. In short, the ISP parameter is written to the ISP 20 in combination with the ISP compensation value at the frame before the frame where the written sensor parameter takes effect in the sensor 10; and at the frame where the written sensor parameter takes effect in the sensor 10, the ISP parameter is rewritten to the ISP 20 without being combined with the ISP compensation value. In the case where the ISP parameter is also written into the ISP 20 in combination with the ISP compensation value at the Nth frame (a frame the same as the frame where the sensor parameter is written into the sensor 10 in the timing sequence), the written sensor parameter already takes effect in the sensor image data stream at the xth frame after the ISP parameter in combination with the ISP compensation value is written into the ISP 20, and at this time, therefore, software compensation in the ISP processing flow by applying the ISP compensation value is no longer required.

Exemplarily, a further explanation is given below by taking the predetermined number of frames as 2 frames and x=1 as an example. The ISP 20 calculates the sensor parameter and ISP parameter every 2 frames. In the case where the sensor parameter and the ISP parameter are calculated at the Nth frame as the current frame, the calculated sensor parameter and ISP parameter (after being combined with the ISP compensation value) may be written to the sensor 10 and the ISP 20 at the (N+2)th frame respectively. The sensor parameter takes effect after x (x=1) frames after being written into the sensor 10, that is, the sensor parameter calculated at the Nth frame takes effect at the (N+2+x)th frame (i.e., the (N+3)th frame); the ISP parameter combined with the ISP compensation value takes effect at the (N+2)th frame. At the (N+2+x)th frame (i.e., the (N+3)th frame), the calculated ISP parameter is written into the ISP 20 again without being combined with the ISP compensation value, because at the (N+3)th frame, the written sensor parameter already takes effect in the sensor 10, and therefore, the image data of the (N+3)th frame acquired by the ISP 20 from the sensor 10 is the image data in which the parameter already takes effect, and at this time, the ISP compensation value does not need to be applied for compensation in the ISP processing flow.

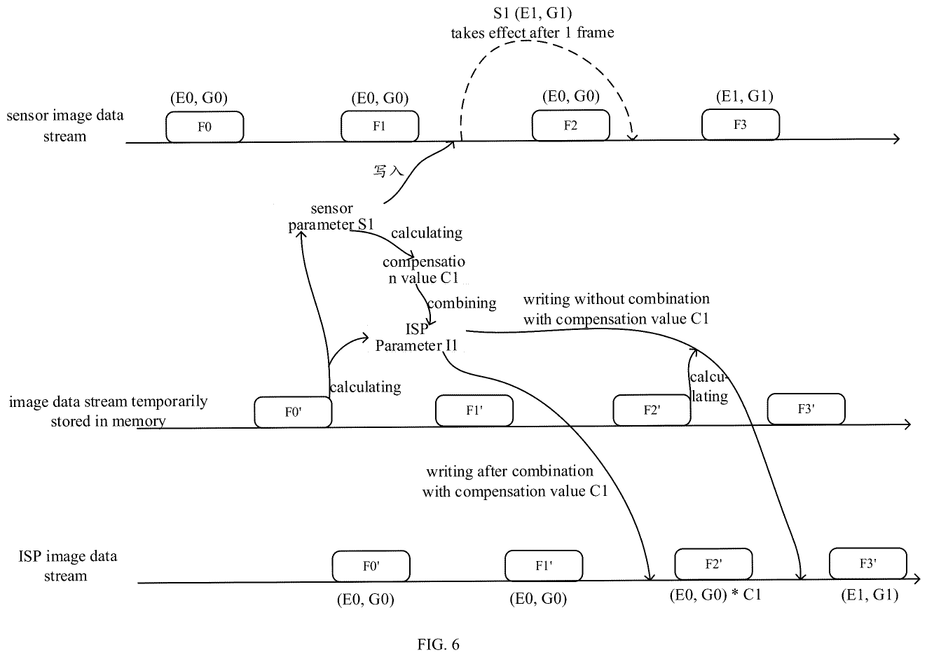

For example, referring to FIG. 6, FIG. 6 is another schematic operation diagram of the image processing system according to the second embodiment of the present application, and the Offline mode is adopted for the operation. The ISP 20 calculates the sensor parameter S1 (including the exposure time parameter E1 and the gain parameter G1) and the ISP parameter at the frame F0′, and calculates the ISP compensation value C1. The sensor parameter S1 (including the exposure time parameter E1 and the gain parameter G1) is written to the sensor 10 at the frame F2, and in the sensor image data stream, the exposure time parameter E1 and the gain parameter G1 take effect at the frame F3. The ISP parameter I1 (after being combined with the ISP compensation value) is written to the ISP 20 at the frame F2′ and takes effect at the frame F2′, and the frame F2′ output by the ISP 20 exhibits an image parameter E0×G0×C1 which is equal to E1×G1. Since the effect taking parameters in the sensor 10 at the frame F3 in the sensor image data stream are E1 and G1, that is, the calculated parameters already take effect in the sensor 10 at the frame F3, in the ISP image data stream, compensation for E1 and G1 already taking effect at the corresponding frame F3′ is not needed, so that the ISP parameter I1 is rewritten to the ISP 20 without being combined with the ISP compensation value C1 at the frame F3′, and an image parameter exhibited by the frame F3′ output by the ISP 20 is E1×G1. Then, the ISP 20 performs the next calculation at the frame F2′ to calculate a new sensor parameter and ISP parameter.

Processing for the subsequent frame in FIG. 6 is similar to the above process, is not repeated in the drawing, and is not repeated herein.

In the example of FIG. 6, since it takes a certain time for the image data to be transmitted through the memory, and it also takes a certain time for the ISP to calculate the sensor parameter and the ISP parameter, the sensor parameter and the ISP parameter calculated at F0′ are written into the sensor 10 and the ISP 20 respectively at the frame F2 (or F2′). In an ideal case, the sensor parameter and the ISP parameter calculated at F0′ can also be written immediately to the sensor 10 and the ISP 20 at the frame F1 (or F1′) without considering the transmission time and the calculation time. In other embodiments, the sensor parameter and the ISP parameter may also be written to the sensor 10 and the ISP 20 at a last frame of more frames after the frame for the calculation.

In some embodiments, the image processing system 100 employs the Inline mode, that is, the acquiring unit 220 of the ISP 20 may be configured to acquire each frame of image data collected by the sensor 10 directly from the sensor 10; in this case, the predetermined number of frames may be 1 frame (for example, see the example of FIG. 5).

In this case, the ISP 20 directly acquires each frame of image data collected by the sensor 10 from the sensor 10 to calculate the sensor parameter, the ISP parameter, and the ISP compensation value. Specifically, the ISP 20 calculates the sensor parameter and the ISP parameter as well as ISP compensation value every 1 frame. That is, the calculation cycle of the ISP 20 is 1 frame, and correspondingly, the writing cycle of the ISP 20 is also 1 frame. For example, in the case where the sensor parameter and the ISP parameter are calculated at the Nth frame as the current frame, the calculated sensor parameter and ISP parameter (after being combined with the ISP compensation value) may be written to the sensor 10 and the ISP 20 respectively at the (N+1)th frame. In the ISP processing flow, the ISP parameter (after being combined with the ISP compensation value) is written in each frame, and the ISP parameter takes effect immediately at the written frame, so that a total effect taking cycle of the image data output by the ISP 20 is 1 frame. According to this embodiment, the ISP 20 performs a calculation and writes the compensation value every 1 frame, so that the delay in the Inline mode is further reduced, and the processed image stream output by the ISP 20 can reflect the change of the real-time scenario more quickly.

In some embodiments, the image processing system 100 includes a plurality of sensors 10; the ISP 20 schedules a processing timing sequence of the image data collected by the plurality of sensors according to a calculation cycle of the image data collected by each sensor.

Specifically, the image processing system 100 includes a plurality of sensors 10, and the ISP 20 needs to process the plurality of frames of image data collected by each sensor 10 and output the processed image data streams respectively. In order to avoid data congestion in the ISP 20, the ISP 20 schedules the processing timing sequence according to the calculation cycle of the image data collected by each sensor 10. Since the ISP 20 performs one calculation every predetermined number of frames for the image data of each sensor 10, the calculation cycle is the aforementioned predetermined number of frames, for example, 1 frame, 2 frames, 3 frames, . . . etc. Additionally, the processing timing sequence of the image data collected by the plurality of sensors 10 may also be scheduled by considering parameter processing speeds (e.g., computation speed and writing speed) of the ISP 20, so that only one processing needs to be performed at the same moment, thus further increasing an efficiency of the image processing system 100.

The image processing system according to the present application represents a significant advancement over the prior art. In the prior art, taking Sony Sensor automatic exposure as an example, as a response time of the exposure/gain, an effect is taken at the (N+2)th frame after the written frame (Nth frame) of the register, ambient light changes from dark to bright, and the exposure/gain of the ISP can get into a next stable state from one stable state; in a conventional processing flow, a convergence cycle of ISP processing is consistent with an effect taking cycle of the register of the image sensor, the convergence cycle of the whole process is an integral multiple of 2 frames, and the image output by the ISP has an obvious delay relative to the change of the real-time scenario. In the present application, the writing and responding cycles of the register of the image sensor are fully considered, and a video convergence speed introduced by the dynamic change of the scenario in the ISP processing flow is increased by adopting dynamic compensation in the ISP image data stream, thereby further improving an ISP processing performance in the whole flow.

In practical verification, when the ambient light suddenly becomes bright, the image processing system automatically adjusts the exposure and gain, the image starts to converge from a stable state to the next stable state, and under the same condition, the convergence speed of the image processing system according to the present application is increased by about 50%. For example, under the same condition, the convergence cycle according to the conventional solution is approximately 27 frames, that is, the output image stream gets into a new stable state after 27 frames when the ambient light changes suddenly; the image processing system according to the present application has a convergence cycle of approximately 16 frames, that is, the output image stream gets into a new stable state after 16 frames when the ambient light changes suddenly, and no obvious flicker is observed in the convergence process.

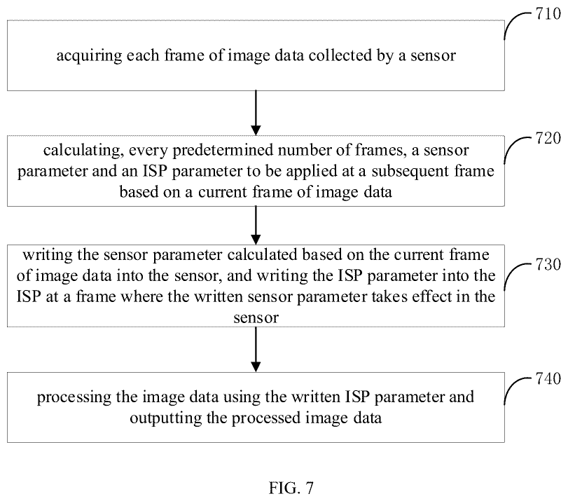

In another aspect, the present application provides an image processing method for processing a stream including multiple frames of image data. Referring to FIG. 7, FIG. 7 is a flowchart of the image processing method according to an embodiment of the present application, and the image processing method includes the following steps S710-S740. It will be readily appreciated that the image processing method is performed by an ISP such as the ISP 20 in the image processing system 100 according to the previous embodiment.
S710: acquiring each frame of image data collected by a sensor;
S720: calculating, every predetermined number of frames, a sensor parameter and an image signal processor (ISP) parameter to be applied at a subsequent frame based on a current frame of image data;
S730: writing the sensor parameter calculated based on the current frame of image data into the sensor, and writing the ISP parameter into the ISP at a frame where the written sensor parameter takes effect in the sensor; and
S740: processing the image data using the written ISP parameter and outputting the processed image data.

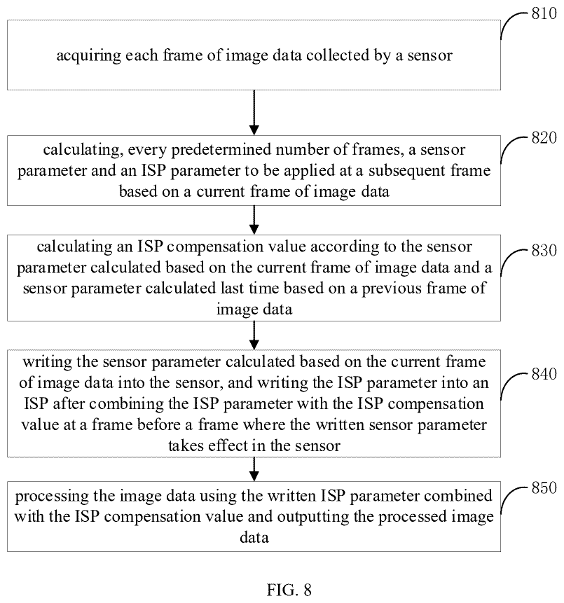

In another aspect, the present application provides an image processing method for processing a stream including multiple frames of image data. Referring to FIG. 8, FIG. 8 is a flowchart of the image processing method according to an embodiment of the present application, and the image processing method includes the following steps S810-S850. It will be readily appreciated that the image processing method is performed by an ISP such as the ISP 20 in the image processing system 100 according to the previous embodiment.
S810: acquiring each frame of image data collected by a sensor;
S820: calculating, every predetermined number of frames, a sensor parameter and an image signal processor (ISP) parameter to be applied at a subsequent frame based on a current frame of image data;
S830: calculating an ISP compensation value according to the sensor parameter calculated based on the current frame of image data and a sensor parameter calculated last time based on a previous frame of image data;
S840: writing the sensor parameter calculated based on the current frame of image data into the sensor, and writing the ISP parameter into an ISP after combining the ISP parameter with the ISP compensation value at a frame before a frame where the written sensor parameter takes effect in the sensor; and
S850: processing the image data using the written ISP parameter combined with the ISP compensation value and outputting the processed image data.

In some embodiments, S830 specifically includes: calculating the ISP compensation value to correspond to a variation between the sensor parameter calculated based on the current frame of image data and the sensor parameter calculated last time based on the previous frame of image data.

In some embodiments, S830 specifically includes: calculating a ratio of the sensor parameter calculated based on the current frame of image data to the sensor parameter calculated last time based on the previous frame of image data as the ISP compensation value; and step S840 specifically includes: writing the sensor parameter calculated based on the current frame of image data into the sensor, and writing the ISP parameter into the ISP after multiplying the ISP parameter by the ISP compensation value at the frame before the frame where the written sensor parameter takes effect in the sensor.

In some embodiments, the step S840 specifically includes:
determining whether the sensor parameter calculated based on the current frame of image data is the same as the sensor parameter calculated last time based on the previous frame of image data; and
if not, writing the sensor parameter calculated based on the current frame of image data into the sensor, and writing the ISP parameter into the ISP after combining the ISP parameter with the ISP compensation value at the frame before the frame where the written sensor parameter takes effect in the sensor.

In some embodiments, the step S840 specifically includes: writing the sensor parameter calculated based on the current frame of image data into the sensor and writing the ISP parameter after combining with the ISP compensation value into the ISP at a last frame of the predetermined number of frames after the current frame.

In some embodiments, the predetermined number is greater than or equal to 2; after being written into the sensor, the sensor parameter takes effect after x frame(s), x being a positive integer less than the predetermined number; the step S810 specifically includes: acquiring each frame of image data collected by the sensor from a memory; and the image processing method further includes S860: rewriting the ISP parameter into the ISP without combining the ISP parameter with the ISP compensation value at the frame where the written sensor parameter takes effect in the sensor.

In some embodiments, the predetermined number is 1; and the step S810 specifically includes: directly acquiring each frame of image data collected by the sensor from the sensor.

For details of the image processing method according to the present application, reference can be made to the description of the image processing system according to the present application, and details are not repeated herein.

In another aspect, the present application provides an image signal processor, including a logic circuit, the logic circuit being capable of executing a computer program stored in a memory, and the logic circuit, when executing the computer program, implementing the image processing method according to the embodiment of the present application.

For details of the image signal processor according to the present application, reference can be made to the description of the image processing system according to the present application, and details are not repeated herein.

In another aspect, the present application provides a non-transitory computer-readable storage medium having a computer program stored thereon, the computer program, when executed by a processor, implementing the image processing method according to the embodiment of the present application.

For details of the non-transitory computer-readable storage medium according to the present application, reference can be made to the description of the image processing system according to the present application, and details are not repeated herein.

In another aspect, the present application provides a computer program product, including a computer program, the computer program, when executed by a processor, implementing the image processing method according to the embodiment of the present application.

For details of the computer program product according to the present application, reference can be made to the description of the image processing system according to the present application, and details are not repeated herein.

The technical features of the above-mentioned embodiments can be combined arbitrarily. In order to make the description concise, not all possible combinations of the technical features are described in the embodiments. However, as long as there is no contradiction in the combination of these technical features, the combinations should be considered as in the scope of the specification.

The above-described embodiments are only several implementations of the present invention, and the descriptions are relatively specific and detailed, but they should not be construed as limiting the scope of the present invention. It should be understood by those of ordinary skill in the art that various modifications and improvements can be made without departing from the concept of the present invention, and all fall within the protection scope of the present invention. Therefore, the protection scope of the present invention should be subject to the appended claims.

1. (canceled)

2. An image processing system, comprising:
a sensor configured to collect multiple frames of image data, after being written into the sensor, a sensor parameter taking effect after at least 1 frame; and
an image signal processor (ISP), after being written into the ISP, an ISP parameter taking effect immediately at a written frame, wherein the ISP is configured to:
acquire each frame of image data collected by the sensor;
calculate, every predetermined number of frames, a sensor parameter and an ISP parameter to be applied at a subsequent frame based on a current frame of image data, and calculate an ISP compensation value according to the sensor parameter calculated based on the current frame of image data and a sensor parameter calculated last time based on a previous frame of image data;
write the sensor parameter calculated based on the current frame of image data into the sensor, and write the ISP parameter into the ISP after combining the ISP parameter with the ISP compensation value at a frame before a frame where the written sensor parameter takes effect in the sensor; and
to process the image data using the written ISP parameter combined with the ISP compensation value and output the processed image data.

3. The image processing system according to claim 2, wherein the ISP is configured to calculate the ISP compensation value to correspond to a variation between the sensor parameter calculated based on the current frame of image data and the sensor parameter calculated last time based on the previous frame of image data.

4. The image processing system according to claim 3, wherein the ISP is configured to:
calculate, as the ISP compensation value, a ratio of the sensor parameter calculated based on the current frame of image data to the sensor parameter calculated last time based on the previous frame of image data; and
write the ISP parameter into the ISP after multiplying the ISP parameter by the ISP compensation value.

5. The image processing system according to claim 2, wherein the ISP is configured to:
determine whether the sensor parameter calculated based on the current frame of image data is the same as the sensor parameter calculated last time based on the previous frame of image data; and
in response to the sensor parameter calculated based on the current frame of image data is not the same as the sensor parameter calculated last time based on the previous frame of image data, write the sensor parameter calculated based on the current frame of image data into the sensor, and write the ISP parameter into the ISP after combining the ISP parameter with the ISP compensation value at the frame before the frame where the written sensor parameter takes effect in the sensor.

6. The image processing system according to claim 2, wherein the ISP configured to:
write the sensor parameter calculated based on the current frame of image data into the sensor and write the ISP parameter after combining with the ISP compensation value into the ISP at a last frame of the predetermined number of frames after the current frame.

7. The image processing system according to claim 6, comprising a memory, the memory being configured to temporarily store the multiple frames of image data collected by the sensor;
wherein the predetermined number is greater than or equal to 2;
wherein after being written into the sensor, the sensor parameter takes effect after x frame(s), x being a positive integer less than the predetermined number;
wherein the ISPacquiring is configured to:
acquire each frame of image data collected by the sensor from the memory; and
rewrite the ISP parameter into the ISP without combining the ISP parameter with the ISP compensation value at the frame where the written sensor parameter takes effect in the sensor.

8. The image processing system according to claim 6, wherein:
the ISP is configured to: directly acquire each frame of image data collected by the sensor from the sensor; and
the predetermined number is 1.

9. The image processing system according to claim 2, wherein the image processing system comprises a plurality of sensors, wherein the ISP schedules a processing timing sequence of the image data collected by the plurality of sensors according to a calculation cycle of the image data collected by each sensor.

10. (canceled)

11. An image processing method for processing a stream comprising multiple frames of image data, comprising:
acquiring each frame of image data collected by a sensor;
calculating, every predetermined number of frames, a sensor parameter and an image signal processor (ISP) parameter to be applied at a subsequent frame based on a current frame of image data;
calculating an ISP compensation value according to the sensor parameter calculated based on the current frame of image data and a sensor parameter calculated last time based on a previous frame of image data;
writing the sensor parameter calculated based on the current frame of image data into the sensor, and writing the ISP parameter into the ISP after combining the ISP parameter with the ISP compensation value at a frame before a frame where the written sensor parameter takes effect in the sensor; and
processing the image data using the written ISP parameter combined with the ISP compensation value and outputting the processed image data.

12. An image signal processor, comprising a logic circuit, the logic circuit being capable of executing a computer program stored in a memory, and the logic circuit, when executing the computer program, implementing the image processing method according to claim 11.

13. A non-transitory computer-readable storage medium having one or more instructions stored thereon that, when executed by a processor, causes the processor to perform operations of an image processing method, the operations comprising:
acquiring each frame of image data collected by a sensor;
calculating, every predetermined number of frames, a sensor parameter and an image signal processor (ISP) parameter to be applied at a subsequent frame based on a current frame of image data;
calculating an ISP compensation value according to the sensor parameter calculated based on the current frame of image data and a sensor parameter calculated last time based on a previous frame of image data;
writing the sensor parameter calculated based on the current frame of image data into the sensor, and writing the ISP parameter into the ISP after combining the ISP parameter with the ISP compensation value at a frame before a frame where the written sensor parameter takes effect in the sensor; and
processing the image data using the written ISP parameter combined with the ISP compensation value and outputting the processed image data.

14. A computer program product, comprising a computer program, the computer program, when executed by a processor, implementing the image processing method according to claim 11.

15. The image processing method according to claim 11, wherein the ISP is configured to calculate the ISP compensation value to correspond to a variation between the sensor parameter calculated based on the current frame of image data and the sensor parameter calculated last time based on the previous frame of image data.

16. The image processing method according to claim 15, wherein the ISP is configured to:
calculate, as the ISP compensation value, a ratio of the sensor parameter calculated based on the current frame of image data to the sensor parameter calculated last time based on the previous frame of image data; and
write the ISP parameter into the ISP after multiplying the ISP parameter by the ISP compensation value.

17. The image processing method according to claim 11, wherein the ISP is configured to:
determine whether the sensor parameter calculated based on the current frame of image data is the same as the sensor parameter calculated last time based on the previous frame of image data; and
in response to the sensor parameter calculated based on the current frame of image data is not the same as the sensor parameter calculated last time based on the previous frame of image data, write the sensor parameter calculated based on the current frame of image data into the sensor, and write the ISP parameter into the ISP after combining the ISP parameter with the ISP compensation value at the frame before the frame where the written sensor parameter takes effect in the sensor.

18. The image processing method according to claim 11 wherein the ISP is configured to:
write the sensor parameter calculated based on the current frame of image data into the sensor and write the ISP parameter after combining with the ISP compensation value into the ISP at a last frame of the predetermined number of frames after the current frame.

19. The image processing method according to claim 18, wherein the ISP is configured to:
directly acquire each frame of image data collected by the sensor from the sensor; and the predetermined number is 1.

20. The image processing method according to claim 11, wherein the ISP schedules a processing timing sequence of the image data collected by a plurality of sensors according to a calculation cycle of the image data collected by each sensor.

21. The non-transitory computer-readable storage medium according to claim 13, wherein the ISP is configured to calculate the ISP compensation value to correspond to a variation between the sensor parameter calculated based on the current frame of image data and the sensor parameter calculated last time based on the previous frame of image data.

22. The non-transitory computer-readable storage medium according to claim 21, wherein the ISP is configured to:
calculate, as the ISP compensation value, a ratio of the sensor parameter calculated based on the current frame of image data to the sensor parameter calculated last time based on the previous frame of image data; and
write the ISP parameter into the ISP after multiplying the ISP parameter by the ISP compensation value.
